(19) United States
(12) Patent Application Publication
(10) Pub. No.: US 2022/0149773 A1
(43) Pub. Date: May 12, 2022

(54) SOLAR TRACKER BUSHING ASSEMBLY

(71) Applicant: A Raymond et Cie, Grenoble (FR)

(72) Inventors: Jason REZNAR, Birmingham, MI (US); William TELLER, Lake Orion, MI (US)

(21) Appl. No.: 17/093,675

(22) Filed: Nov. 10, 2020

(51) Int. Cl. H02S 20/32; F16C 23/02; F16C 33/04; F16C 33/08; F16C 41/00

(52) U.S. Cl. CPC H02S 20/32; F16C 23/02; F16C 33/046; F24S 2030/15; F16C 41/005; F16C 2300/32; F16C 33/08

(57) ABSTRACT

An improved bushing assembly for a solar tracker is provided. The bushing assembly includes a bushing that is seated within a ring-shaped bracket. The bushing includes an annular ridge that is disposed within an annular channel in the bracket. Alternatively, the bracket includes an annular ridge that is disposed within an annular channel in the bushing. In each configuration, the bushing is retained in position during installation of the bracket. The bushing defines an internal passage for a solar tracker crossbar and provides complete rotational freedom for the crossbar about its lengthwise axis and limited rotational freedom for the crossbar about the remaining orthogonal axes. Additional features including side skirts for minimizing the entry of debris between the bushing and the bracket, a resilient latch for securing bracket sections together, and vertical openings in the bracket sections to allow debris to escape.

### FIELD OF THE INVENTION

The present invention relates to bushing assemblies, and in particular, bushing assemblies for solar trackers and other devices.

### BACKGROUND OF THE INVENTION

Solar panels can be implemented as fixed systems or with solar trackers. As the name suggests, fixed systems include a stationary array of photovoltaic panels for converting sunlight into a voltage source, but with sub-optimal positioning. By contrast, solar trackers reposition an array of photovoltaic panels throughout hours of daylight to achieve improved efficiency in the generation of electricity. Solar trackers include single-axis systems and dual-axis systems to control the azimuth and/or elevation of an array of photovoltaic panels, either in a stepwise fashion or continuously.

Particularly for large scale commercial operations, multiple photovoltaic panels can be supported by a lengthwise beam or crossbar. The crossbar is rigidly joined to each photovoltaic panel, such that rotation of the crossbar simultaneously controls the azimuth and/or elevation of each of the photovoltaic panels. The crossbar can be supported by a series of load-bearing stanchions, each including a bushing within a ring-shaped bracket. However, known bushings suffer from a number of shortcomings. For example, known bushings are easily displaced during installation. In addition, known bushings can trap dirt against the outer ring-shaped bracket, and the outer ring-shaped bracket can be difficult to fasten together.

Accordingly, there remains a continued need for an improved bushing assembly for solar trackers and other devices. In particular, there remains a continued need for an improved bushing assembly that can be more easily installed about a crossbar for a solar tracker and that minimizes the intrusion of dirt and debris therein.

### SUMMARY OF THE INVENTION

An improved bushing assembly for a solar tracker is provided. The bushing assembly includes a bushing that is seated within a ring-shaped bracket. The bushing includes an annular ridge that is disposed within an annular channel in the bracket. Alternatively, the bracket includes an annular ridge that is disposed within an annular channel in the bushing. In each configuration, the bushing is retained in position during installation of the bracket. The bushing defines an internal passage for a solar tracker crossbar and provides complete rotational freedom for the crossbar about its lengthwise axis and limited rotational freedom for the crossbar about the remaining orthogonal axes. Additional features including side skirts for minimizing the entry of debris between the bushing and the bracket, a resilient latch for securing bracket sections together, and vertical openings in the bracket sections to allow debris to escape.

In another embodiment, the bushing includes a first section joined to a second section, the first and second sections cooperating to define an internal passage for a solar tracker crossbar, the internal passage optionally being polygonal. The first bushing section includes a first post and a first opening in complementary alignment with a second opening and a second post of the second bushing section, respectively, to secure the first and second bushing sections together about the solar tracker crossbar. The outer radial surface of the bushing is axially convex, such that the outer radial surface slopes towards a first side edge and a second side edge.

In one embodiment, the bracket includes an upper bracket section joined to a lower bracket section to cooperatively define an inner radial surface. The inner radial surface is axially concave, such that the inner radial surface forms a truncated spherical raceway for the bushing. The bracket also includes an annular channel that is recessed relative to the inner radial surface, being centrally disposed between a first side thereof and a second side thereof. The annular channel includes a width that is slightly greater than the width of the annular ridge extending about the outer radial surface of the bushing, such that the bushing is permitted limited rotation about the X and Y axes, for example +/−10 degrees, further optionally +/−5 degrees.

In another embodiment, the upper bracket section and the lower bracket section are each C-shaped, and the upper bracket section includes a first flange and a second flange. Each such flange includes is secured to an upward facing portion of the lower bracket section and includes a fastener aperture in alignment with a through-hole in the lower bracket section. In addition, the lower bracket section includes a resilient latch for engaging the first flange of the upper bracket section. The upper bracket section additionally includes a first side skirt along a first periphery thereof and a second side skirt along a second periphery thereof, the first and second side skirts preventing the entry of debris between the bushing and the bracket.

Though the embodiments noted above include an annular ridge and channel construction, not all embodiments include this feature. For example, other embodiments omit this feature, and instead include a bracket with an uninterrupted inner radial surface and a bushing with an uninterrupted outer radial surface. In these embodiments, the bushing assembly can include one or more of the following features: an upper bracket section including a first side skirt along a first periphery thereof and a second side skirt along a second periphery thereof, a lower bracket section including first and second resilient latches for engaging the upper bracket section, and/or a lower bracket section including a plurality of vertically extending openings extending entirely therethrough in fluid communication with lateral channels that discharge debris laterally. Still other combinations of features are possible in other embodiments.

These and other features and advantages of the present invention will become apparent from the following description of the invention, when viewed in accordance with the accompanying drawings and appended claims.

### BRIEF DESCRIPTION OF THE DRAWINGS

FIG. 1 is a perspective view of a bushing assembly for a solar tracker.

FIG. 2 is an exploded view of the bushing assembly of FIG. 1.

FIG. 3 is a cross-sectional view of the bushing assembly of FIG. 1.

FIG. 4 is a cross-sectional view of a crossbar within a bushing assembly.

FIG. 5 is a cross-sectional view of a bushing assembly including a T-channel.

FIG. 6 is an exploded view of the upper bracket for a bushing assembly.

FIG. 7 is a first close-up view of the bracket of FIG. 1.

FIG. 8 is a second close-up view of the bracket of FIG. 1.

FIG. 9 is a perspective view of the lower bracket of a bushing assembly.

FIG. 10 is a perspective view of a modified upper bracket and upper bushing.

FIG. 11 is a cross-section of a crossbar within the bushing assembly of FIG. 10.

FIG. 12 is a close-up of the tubular insert shown in FIG. 2.

FIG. 13 is a perspective view of a solar tracker crossbar and bushing assembly.

### DETAILED DESCRIPTION OF THE CURRENT EMBODIMENT

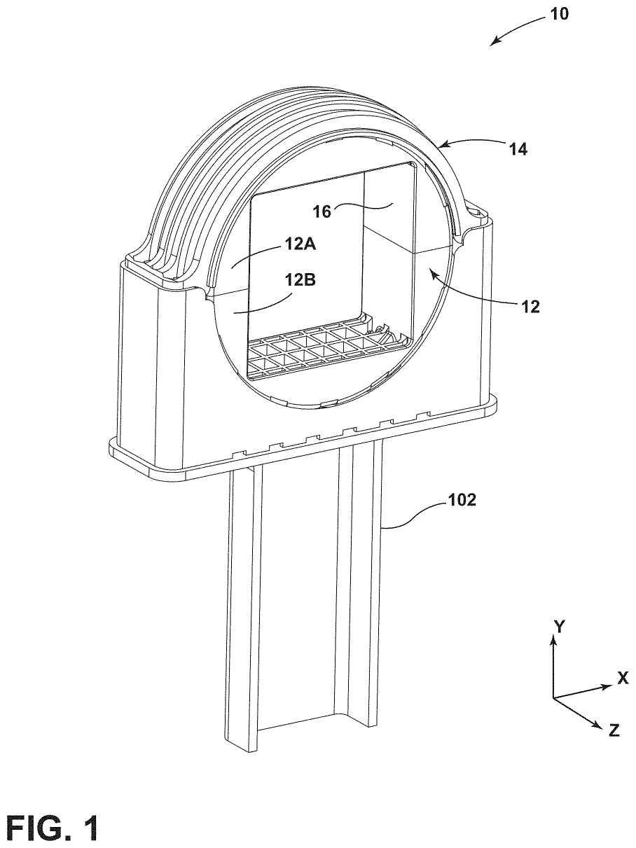

Referring to FIG. 1, a bushing assembly in accordance with one embodiment is illustrated and generally designated 10. The bushing assembly 10 includes a bushing 12 that is supportably received within a bracket 14, the bushing 12 including an opening 16 for a solar tracker crossbar. The bushing 12 and the bracket 14 include a complementary ridge and channel to limit movement of the bushing 12 relative to the bracket 14. Each feature is discussed below. Though described and illustrated in connection with a solar tracker, the bushing assembly 10 can be used in other applications as desired, whether now known or hereinafter developed.

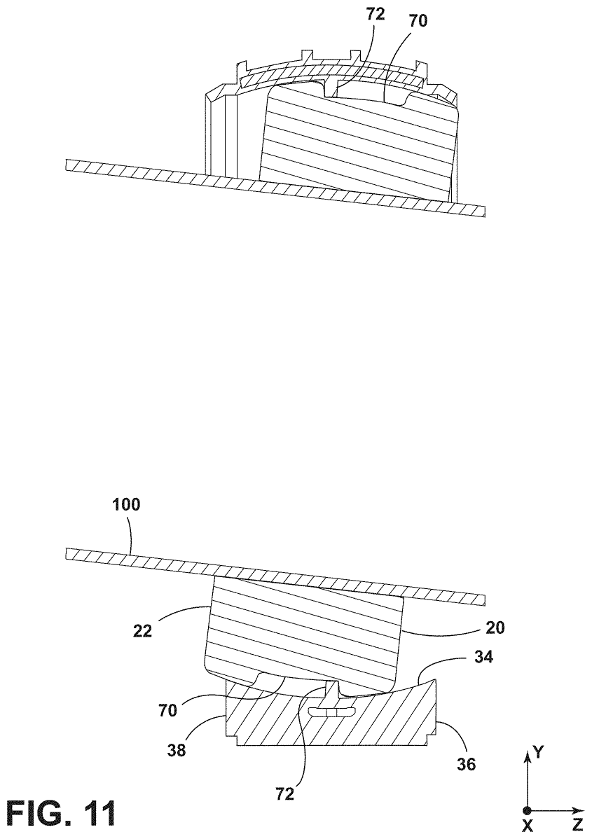

As best shown in FIGS. 1-3, the bushing 12 includes a first bushing section 12A and a second bushing section 12B, each being made of an elastomeric material and cooperating to defining an opening 16 therethrough. The bushing 12 includes a continuous outer radial surface 18 extending between a first side surface 20 and a second side surface 22. The outer radial surface 18 is axially convex, such that the outer radial surface 18 includes a gradually decreasing radius of curvature as it slopes toward the first side surface 20 and the second side surface 22. In the embodiment shown in FIGS. 1-9, the bushing 12 includes an annular radial ridge 24 extending about the outer radial surface 18, being centrally located between the first side surface 20 and the second side surface 22. In the embodiment shown in FIGS. 10-11, however, the bushing 12 includes an annular channel 70 that is recess from the outer radial surface 18, being centrally located between the first and second side surfaces 20, 22.

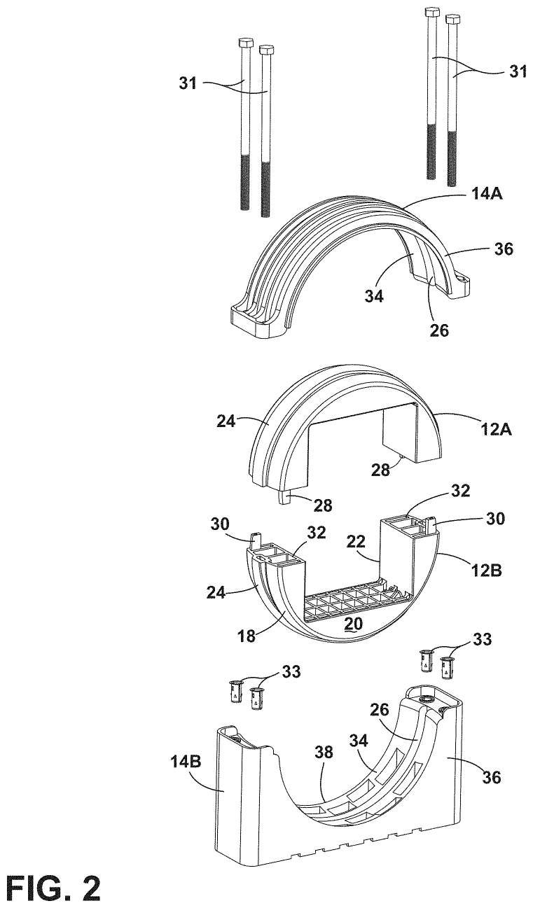

As shown in FIG. 1-2, the first bushing section 12A and the second bushing section 12B are joined together other by interference fit. In particular, each bushing section 12A, 12B includes a flat engagement surface. The flat engagement surface of the first bushing section 12A includes a two posts 28 that are diagonally offset from two posts 30 extending from the flat engagement surface of the second bushing section 12B. The posts 28 are received in openings 32 in the flat engagement surfaces of the opposing bushing section, the openings being material savers that result from the molding of the bushing sections. Collectively, the bushings sections 12A, 12B define a square opening 16 for a crossbar having a square cross-section in the illustrated embodiment, but can include other polygonal or circular openings.

The bracket 14 comprises an upper bracket section 14A and a lower bracket section 14B. Each bracket section 14A, 14B is a semi-circular bracket section, the lower bracket section 14B being joined to a stanchion 102 or other vertical support, and the upper bracket section 14A being joined to the lower bracket section 14B to house the bushing 12 therebetween. While only two bracket sections are shown in the current embodiment, other embodiments can include greater number of bracket sections, for example three bracket sections. Four bolts 31 extend through the upper bracket section 14A and the lower bracket section 14B to secure the bracket assembly 10 to the stanchion 102. The bolts 31 also extend through tubular inserts 33 within openings in the lower bracket section 14B. The tubular inserts 33 prevent the accidental removal of the bolts 31 prior to installation, as discussed more fully below.

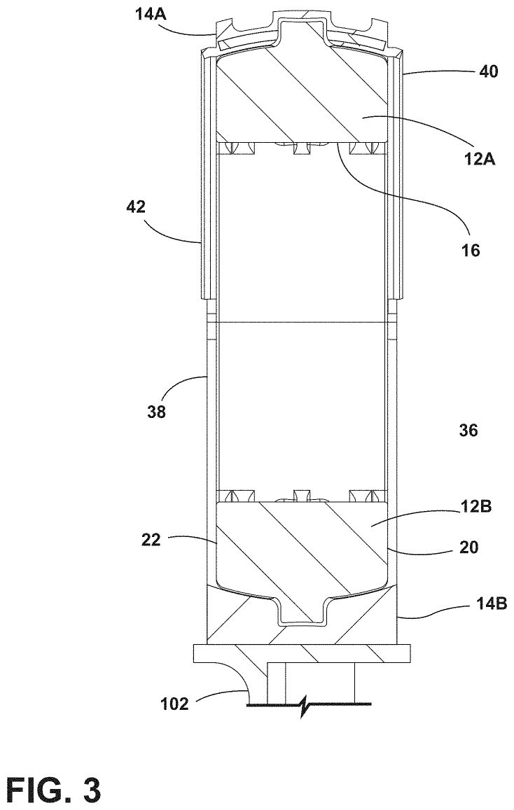

Each bracket section 14A, 14B includes an inner radial surface 34 in engagement with the outer radial surface 18 of the bushing 12. The inner radial surface 34 is axially concave, forming a truncated spherical raceway as shown in FIG. 3. As also shown in FIG. 3, each bracket section 14A, 14B includes an annular channel 26 that is recessed from inner radial surface 34 and that is centrally located between a first side surface 36 and a second side surface 38 of the bracket 14. The first side surface 36 of the upper bracket section 14A includes a first side skirt 40, and the second side 38 of the upper bracket section 14A includes a second side skirt 42. The side skirts 40, 42 extend over the interface between the bushing 12 and the bracket 14 to prevent the introduction of debris therein. The side skirts 40, 42 span about 180 degrees in the illustrated embodiment, being integrally formed with the upper bracket section 14A.

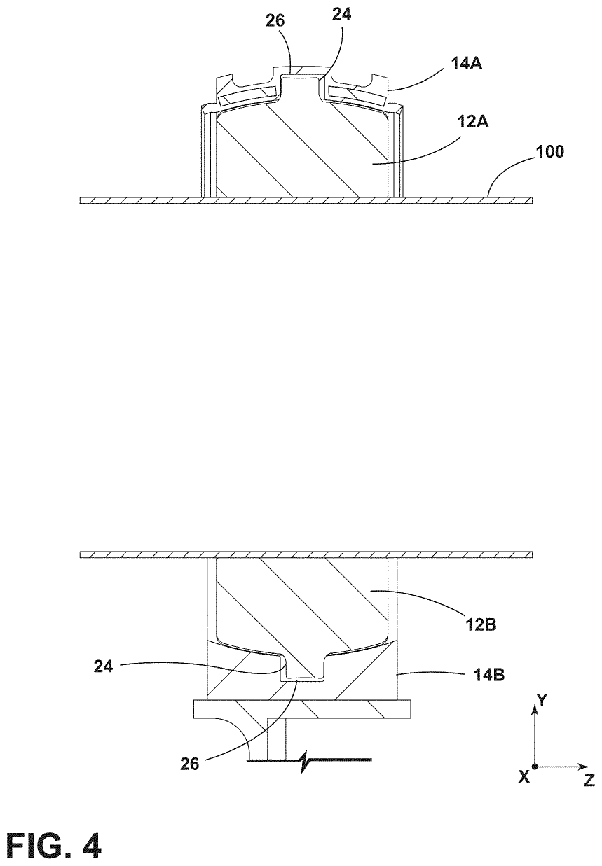

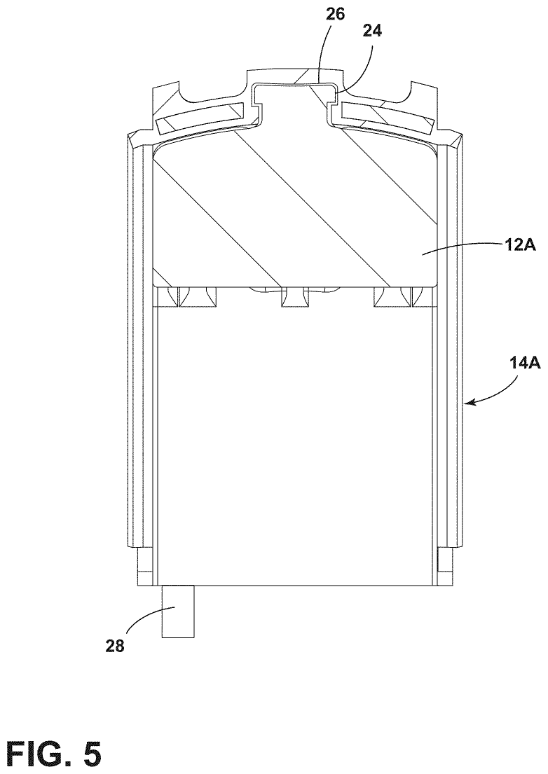

An exemplary crossbar 100 is illustrated in FIG. 4 as being received within the bushing 12. Because the bushing 12 is rotatable with respect to the bracket 14, the crossbar 100 has rotational freedom the Z-axis, which extends through the bushing opening 16. The crossbar 100 has limited rotational freedom about the X-axis and the Y-axis, each being fixed in relation to the bracket 14 (i.e., the reference frame is fixed in relation to the bracket 14). In addition, the width of the annular ridge 24 is less than the width of the annular channel 26. As a result, the bushing 12 is permitted limited rotation about the X- and Y-axes, for example +/−10 degrees, further optionally +/−5 degrees, still further optionally +/−1 degree. As shown in FIG. 4, for example, the crossbar 100 is deflected by about 1 degree about the X axis. As optionally shown in FIG. 5, the annular ridge 24 can include a T-shaped cross-section, and the annular channel 26 can include a corresponding T-channel when in cross-section. In this respect, the bushing 12 is prevented from being removed from the bracket, however the bushing still retains its complete rotational freedom about the Z-axis and limited rotational freedom about the X- and Y-axes.

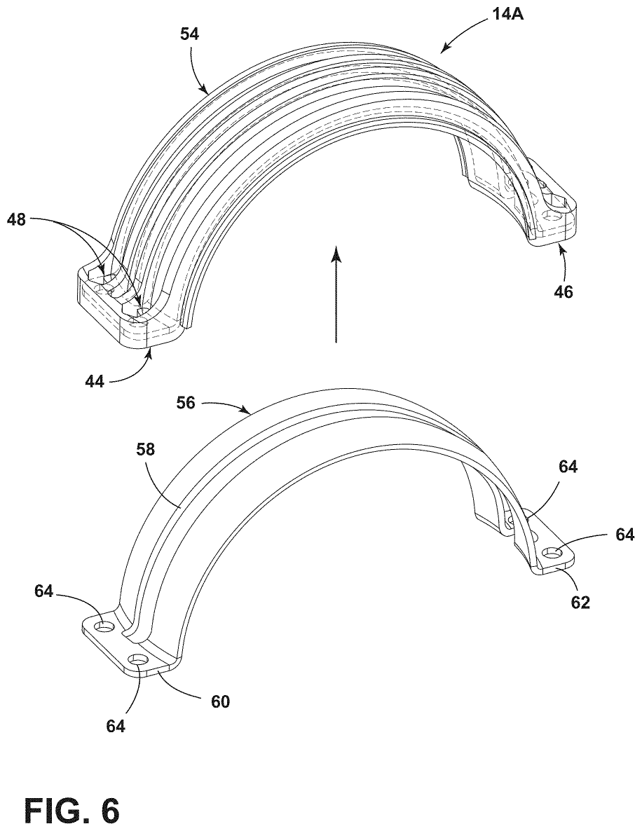

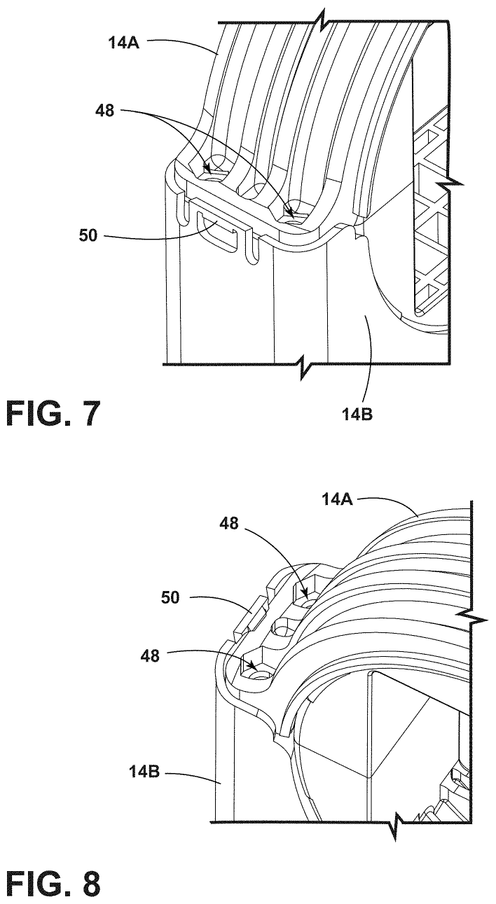

Referring now to FIG. 6, the upper bracket section 14A includes a first flange and a second flange 44, 46. Each flange 44, 46 is secured to an upward facing surface of the lower bracket section 14B and includes fastener apertures 48 in alignment with through-holes 52 in the lower bracket section 14B. In addition, the lower bracket section 14B includes first and second resilient latches 50 for engaging the first and second flanges 44, 46 of the upper bracket section 14A. The first and second resilient latches 50 are shown in close-up in FIGS. 7-8, and function to retain the upper bracket section 14A in place while the fasteners (e.g., bolts) are inserted through the fastener apertures 48 and through-holes 52. As also shown in FIG. 6, the upper bracket 14A is a composite article, being formed from a metal bracket element 56 (e.g., steel) overmolded with a suitable thermoplastic 54. The bracket element 56 includes an axial groove 58 and provides increased strength. The bracket element 56 also includes first and second flanges 60, 62 that include the fastener apertures 64.

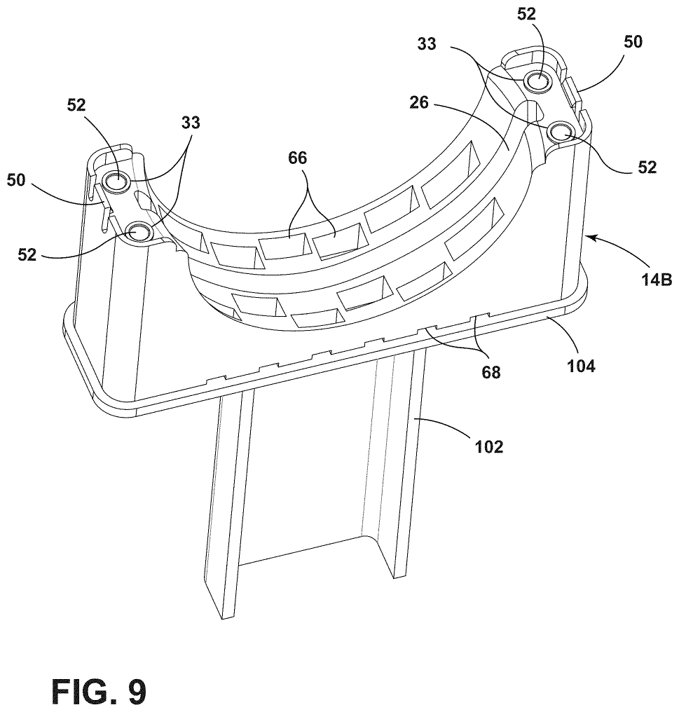

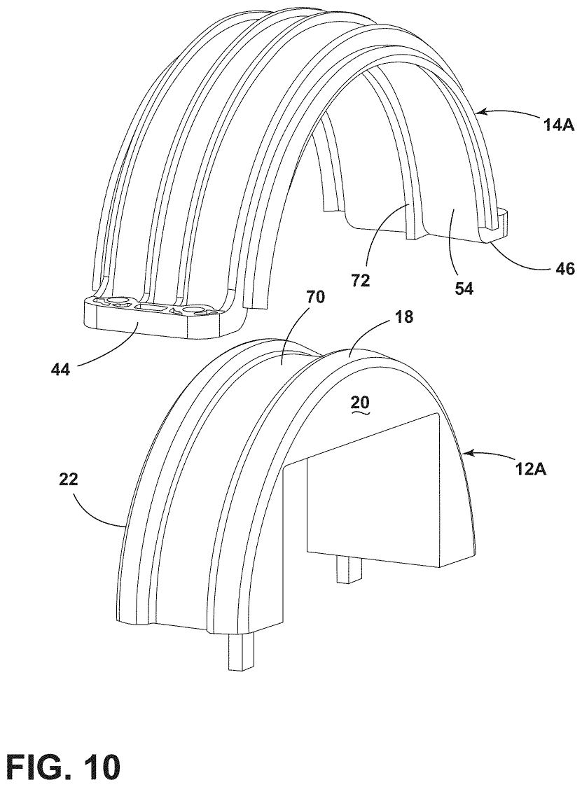

Referring again to FIG. 9, the lower bracket section 14B includes a plurality of vertical openings 66 to allow debris between the bushing 12 and the bracket 14 to escape the bushing assembly 10. The vertical openings 66 extend entirely through the lower bracket section 14B and open to lateral channels 68 that discharge the debris laterally. The lower bracket section 14B is joined to a horizontal plate 104 supported atop a vertical stanchion 102, with the lateral channels 68 being in fluid communication with the vertical openings 66. Though not shown, in other embodiments the bushing assembly 10 includes the application of compressed air, manually or automatically, to forcibly discharge debris through the vertical openings 66 and the lateral channels 68, the debris being otherwise trapped in the bushing assembly 10.

As shown in FIGS. 10 and 11, the bushing 12 can alternatively include an annular channel 70 extending about the outer radial surface 18, being centrally located between the first side surface 20 and the second side surface 22. The annular channel 70 includes a width that is wider than the width of an annular ridge 72 disposed on the inner radial surface 34 of the bracket 14. As a result, the bushing 12 includes rotational freedom about the X and Y axes. As shown in FIG. 11, for example, the bushing 12 is free to rotate +/−6.5 degrees about the X-axis and about the Y-axis. The embodiment of FIGS. 10-11 and otherwise structurally and functionally similar to the embodiment of FIGS. 1-9. In addition, the inner radial surface 34 of the bracket 14 is axially concave, forming a truncated spherical raceway for the bushing 12, and the outer radial surface 18 of the bushing 12 is axially convex, such that the outer radial surface 18 includes a gradually decreasing radius of curvature as it slopes toward the first side surface 20 and the second side surface 22. The bracket 14 circumferentially engages the bushing 12, comprising two semi-circular bracket sections and is secured to the stanchion with screws, nuts, bolts, or other fasteners. The bushing 12 is rotatable within the bracket 14 and therefore the crossbar 100 is rotatable to an infinite number of positions to follow movement of the sun.

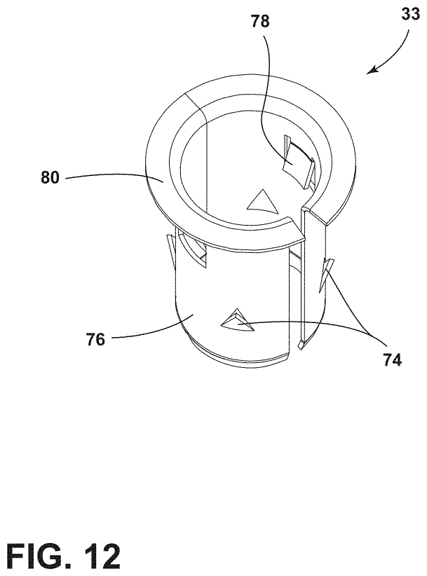

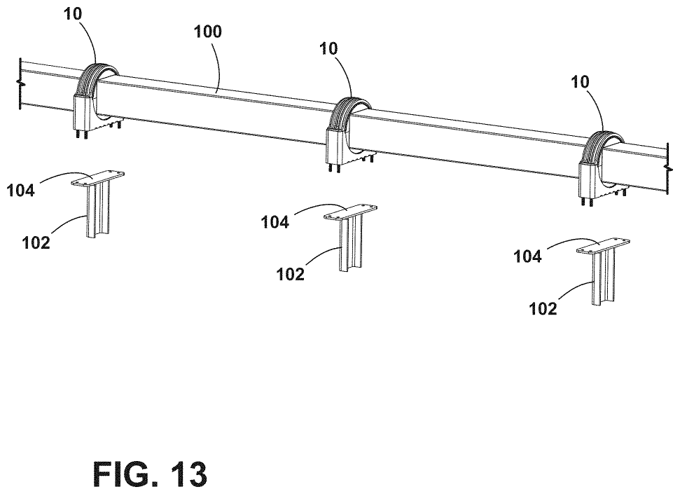

As shown in FIG. 12, each tubular insert 33 includes a plurality of barbs 74 extending outward from a tubular sidewall 76 to prevent the removal of the tubular insert 33 from the through-hole 52 in the lower bracket section 14B. Each tubular insert 33 also includes a resilient tab 78 that projects inward from the tubular sidewall 76 to prevent accidental removal of a bolt 31 prior to tightening. Each tubular insert 33 also includes a collar 80 that lies flat against the upward facing surface of the lower bracket section 14B. The tubular inserts 33 retain the bolts 31 and allow pre-assembly of the upper bracket section 14A to the lower bracket section 14B for shipment, with final assembly being on-site. Three bushing assemblies 10 and a solar tracker crossbar 100 are shown during final assembly in FIG. 13. The bushing assemblies 10 are positionable along the crossbar 100 to ensure alignment with the corresponding stanchions 102. The crossbar 100 is slowly lowered into position, and the bolts 31 extend through openings in each horizontal plate 104. The bolts 31 are tightened, for example to threaded nuts on the underside of the horizontal plate 104. The upper and lower bracket sections 14A, 14B retain the bushing 12 in position, while allowing limited relative movement as described above.

Though the embodiments described above include an annular ridge and channel construction, not all embodiments include this feature. For example, other embodiments of the bushing assembly omit this feature, and instead include a bracket 14 with an uninterrupted inner radial surface and a 12 bushing with an uninterrupted outer radial surface. In these embodiments, the bushing assembly 10 can include one or more of the following features: an upper bracket section 14A including a first side skirt 40 along a first periphery thereof and a second side skirt 42 along a second periphery thereof, a lower bracket section 14B including first and second resilient latches 50 for engaging the first flange 44 and the second flange 46 of the upper bracket section 14A, or a lower bracket section 14B including a plurality of vertical openings 66 in fluid communication with lateral channels 68 that discharge debris laterally. Still other combinations of features are possible in other embodiments.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements by ordinal terms, for example “first,” “second,” and “third,” are used for clarity, and are not to be construed as limiting the order in which the claim elements appear. Any reference to claim elements in the singular, for example, using the articles “a,” “an,” “the” or “said,” is not to be construed as limiting the element to the singular.

1. A bushing assembly comprising:
a bracket including an internal circumferential surface and an annular channel that is recessed relative to the internal circumferential surface; and
a bushing including a first bushing section and a second bushing section, the first and second bushing sections each including an annular ridge extending about an outer radial surface thereof, the outer radial surface of the first and second bushing sections being in engagement with the internal circumferential surface of the bracket, and the annular ridge being disposed within the annular channel of the bracket, such that the bushing is rotatable within the bracket.

2. The bushing assembly of claim 1 wherein the annular channel is positioned midway between a first side surface of the bracket and a second side surface of the bracket.

3. The bushing assembly of claim 1 wherein the annular ridge defines an outer diameter that is greater than an inner diameter defined by the internal circumferential surface of the bracket.

4. The bushing assembly of claim 1 wherein the bracket includes an upper bracket section joined to a lower bracket section.

5. The bushing assembly of claim 4 wherein the upper bracket section includes a first side skirt along a first periphery thereof and a second side skirt along a second periphery thereof.

6. The bushing assembly of claim 4 wherein the upper bracket section includes a first flange defining a fastener aperture in alignment with a through-hole in the lower bracket section.

7. The bushing assembly of claim 4 wherein the lower bracket section includes a resilient latch for engaging the first flange of the upper bracket section.

8. The bushing assembly of claim 1 wherein the lower bracket section includes a plurality of vertically extending openings extending entirely therethrough.

9. The bushing assembly of claim 1 wherein the first bushing section includes a first post and a first opening in complementary alignment with a second opening and a second post of the second bushing section, respectively, to secure the first and second bushing sections together.

10. The bushing assembly of claim 1 wherein the bushing defines a polygonal opening for receipt of a solar tracker crossbar having a polygonal cross-section.

11. A bushing assembly comprising:
a bracket including an upper bracket section joined to a lower bracket section to cooperatively define an inner radial surface, the inner radial surface being axially concave to form a truncated spherical raceway; and
a bushing disposed within the bracket and defining an internal passage therethrough, the bushing including an outer radial surface in engagement with the inner radial surface of the bracket, the outer radial surface of the bushing being axially convex such that the bushing is rotatable relative to the bracket about a first axis and a second axis orthogonal to the first axis;
wherein the bushing includes an annular ridge that is disposed within an annular channel in the bracket, the annular channel being recessed relative to the internal radial surface of the bracket and being centrally disposed between a first side thereof and a second side thereof.

12. The bushing assembly of claim 11 wherein the upper bracket section and the lower bracket section are each C-shaped and wherein the upper bracket section includes a first flange and a second flange each being secured to an upward facing portion of the lower bracket section.

13. The bushing assembly of claim 11 wherein the bushing includes a first bushing section and a second bushing section, the first bushing section including a first post and a first opening in complementary alignment with a second opening and a second post of the second bushing section, respectively, to secure the first and second bushing sections together.

14. The bushing assembly of claim 11 wherein the annular channel includes a width that is greater than a width of the annular ridge.

15. The bushing assembly of claim 11 wherein the lower bracket section includes a plurality of vertically extending openings extending entirely therethrough.

16. The bushing assembly of claim 11 wherein the upper bracket section includes a first side skirt along a first periphery thereof and a second side skirt along a second periphery thereof.

17. The bushing assembly of claim 11 wherein the annular channel comprises a T-slot and wherein the annular ridge includes a T-shaped cross-section.

18. A bushing assembly comprising:
a bracket including an internal circumferential surface and an annular ridge that extends radially inward from the internal circumferential surface; and
a bushing including a first bushing section joined to a second bushing section, the bushing including an outer radial surface that defines an annular channel therein, wherein the outer radial surface of the bushing section is in engagement with the internal circumferential surface of the bracket and wherein the annular ridge of the bracket is disposed within the annular channel of the bushing, such that the bushing is rotatable relative to the bracket about a first axis and a second axis that is orthogonal to the first axis.

19. The bushing assembly of claim 18 wherein the annular channel is positioned midway between a first side surface of the bushing and a second side surface of the bushing.

20. The bushing assembly of claim 18 wherein the annular ridge defines an inner diameter that is less than an outer diameter defined by the outer radial surface of the bracket.
